(19) United States
(12) Patent Application Publication
(10) Pub. No.: US 2013/0176458 A1
(43) Pub. Date: Jul. 11, 2013

(54) Flexible Burst Image Capture System

(71) Applicants: EDWIN VAN DALEN, Eindhoven (NL); THOMAS GARDOS, Providence, RI (US); JOZEF KRUGER, San Jose, CA (US); GEOFFREY BURNS, Palo Alto, CA (US)

(72) Inventors: EDWIN VAN DALEN, Eindhoven (NL); THOMAS GARDOS, Providence, RI (US); JOZEF KRUGER, San Jose, CA (US); GEOFFREY BURNS, Palo Alto, CA (US)

(21) Appl. No.: 13/728,580

(22) Filed: Dec. 27, 2012

Related U.S. Application Data
(60) Provisional application No. 61/585,418, filed on Jan. 11, 2012.

(51) Int. Cl. H04N 5/232

(52) U.S. Cl. CPC H04N 5/232
USPC 348/231.99

(57) ABSTRACT

The present disclosure provides techniques for capturing a series of images. In particular, the present disclosure provides techniques for capturing a series of images using a camera integrated with a computing device, such as a cellular phone. A camera may capture a series of images and store the images in a buffer until all images in the series are captured. The images may be transferred to a storage medium after all images in the series are captured. The images may further be processed before being transferred to the storage medium.

### CROSS-REFERENCE TO RELATED APPLICATION

This application claims the benefit of U.S. Provisional Application No. 61/585,418, filed on Jan. 11, 2012, which is incorporated herein by reference in its entirety for all purposes.

### TECHNICAL FIELD

The present invention relates to digital imaging. In particular, the present invention relates to techniques for capturing a sequence of images using a digital camera.

### BACKGROUND

Modern computing devices continue to incorporate a growing number of components. For example, modern computing devices may include sensors that can provide additional information to the computing device about the surrounding environment. In an example, the sensor may be a digital imager. The imaging sensor may capture an image of a specific area or object within the view of the lens assembly. The camera may capture and process the data. The speed at which the camera processes the data may determine the speed at which the camera is able to capture images. A user may have a variety of reasons for wanting to capture a series of images as quickly as possible, such as action shots, wanting to capture a shot with the best exposure, and wanting to capture a shot with the best focus.

### BRIEF DESCRIPTION OF THE DRAWINGS

Certain exemplary embodiments are described in the following detailed description and in reference to the drawings, in which:

FIG. 1 is a block diagram of a computing device;

FIG. 2 is a flowchart illustrating a method of capturing a burst series of images;

FIG. 3 is a flowchart illustrating a method of capturing a burst series of images;

FIG. 4 is a flowchart illustrating a method of capturing a burst series of images;

FIG. 5 is a flowchart illustrating a method of capturing a burst sequence of images;

FIG. 6 is a flowchart illustrating a method of capturing a burst sequence of images;

FIG. 7 is a flowchart illustrating a method of capturing a burst sequence of images; and

FIG. 8 is a schematic of a mobile device.

### DETAILED DESCRIPTION OF SPECIFIC EMBODIMENTS

Embodiments disclosed herein provide techniques for capturing a burst sequence of images. Burst capture refers to the use of multiple image captures from a camera, usually performed in a stream. The stream may vary in capture parameters to achieve effects depending upon particular use cases. The parameters may include capture series length, exposure, capture frame rate, focus, and other relevant capture parameters.

The images captured in a burst sequence may be processed in various ways. For example, the images may be presented to a user for selection of images to keep. In another example, the images taken while panning during capture of the burst sequence may be stitched together to form a wide angle or panorama image. In a further example, the images may be combined or composited to form a single image. In this example, at least one parameter may be varied to create different effects in the final image. In yet another example, a burst sequence may be taken of a scene including moving objects. The moving object may be identified and removed through comparison between images.

Capture of a burst sequence may be particularly helpful in a sport mode. In sport mode, a burst sequence of a moving scene may be captured. The images may later be presented to the user and the most interesting images may be selected. Moreover, the correspondence between the first image in the capture sequence and the time of the user shutter press is parameterized. For example, the capture sequence may commence before the shutter press. In this case the user may choose to keep an image that was captured before the shutter was pressed.

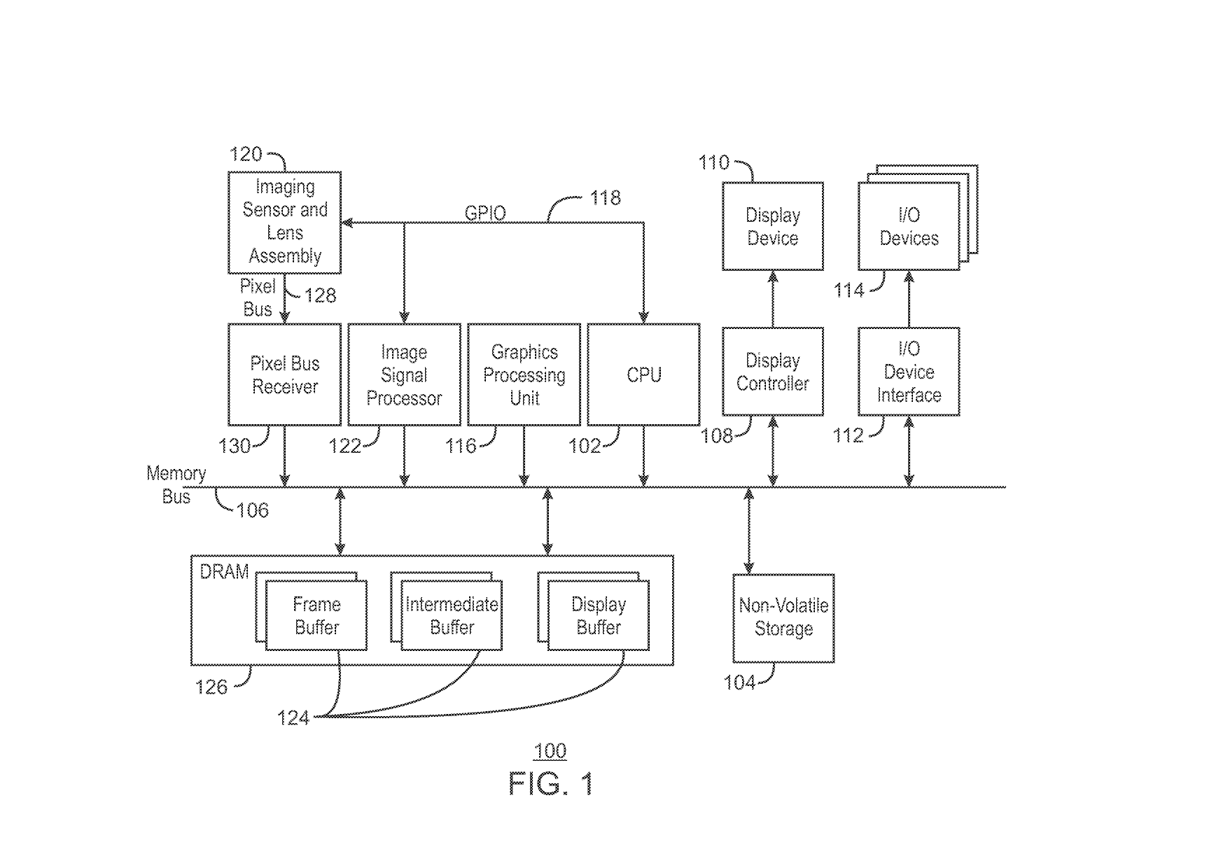

FIG. 1 is a block diagram of a computing device in accordance with an embodiment. The computing device 100 may be, for example, a laptop computer, tablet computer, a digital camera, or mobile device, among others. In particular, the computing device 100 may be a mobile device such as a cellular phone, a smartphone, a personal digital assistant (PDA), or a tablet. The computing device 100 may include a processor or CPU 102 that is configured to execute stored instructions, as well as a memory device 104 that stores instructions that are executable by the processor 102. The processor may be an in-line high throughput image signal processor (ISP). The ISP may enable very high speed capture at full sensor resolution. As such, processing may occur at the full sensor frame rate, without buffering to memory, thus avoiding the resulting latency, memory bandwidth, and power consumption. Alternatively the pixel output form the sensor may be directly written to memory at the full pixel bus bandwidth after which the ISP processes the pixel data from memory. It may be advantageous to decouple the image processor from the sensor output in certain situations. The processor 102 may be a combination of an ISP with a high performance processor, such as an atom processor. The combination may enable powerful computational algorithms to be applied to a burst sequence to achieve unique effects at high performance, enabling responsiveness that is not currently achieved in devices on the market. The processor 102 may be coupled to the memory device 104 by a bus 106. Additionally, the processor 102 can be a single core processor, a multi-core processor, a computing cluster, or any number of other configurations. Furthermore, the computing device 100 may include more than one processor 102.

The computing device includes a storage device 104. The storage device 104 is usually a non-volatile physical memory such as flash storage, hard drive, an optical drive, a thumbdrive, a secure digital (SD) memory card, an array of drives, or any combinations thereof. The storage device 124 may also include remote storage drives. The storage device 124 may include any number of applications 126 that are configured to run on the computing device 100.

The processor 102 may be linked through the bus 106 to a display controller 108 configured to connect the computing device 100 to a display device 110 and to control the display device 110. The display device 110 may include a display screen that is a built-in component of the computing device 100. The display device 110 may also include a computer monitor, television, or projector, among others, that is externally connected to the computing device 100.

The processor 102 may also be connected through the bus 106 to an input/output (I/O) device interface 112 configured to connect the computing device 100 to one or more I/O devices 114. The I/O devices 114 may include, for example, a keyboard and a pointing device, wherein the pointing device may include a touchpad or a touchscreen, among others. The I/O devices 114 may be built-in components of the computing device 100, or may be devices that are externally connected to the computing device 100.

The computing device 100 may also include a graphics processing unit (GPU) 116. As shown, the CPU 102 may be coupled through the bus 106 to the GPU 116. The GPU 116 may be configured to perform any number of graphics operations within the computing device 100. For example, the GPU 116 may be configured to render or manipulate graphics images, graphics frames, videos, or the like, to be displayed to a user of the computing device 100. In some embodiments, the GPU 116 includes a number of graphics engines, wherein each graphics engine is configured to perform specific graphics tasks, or to execute specific types of workloads.

The central processor 102 or image processor may further be connected through a control bus or interface 118, such as GPIO, to an imaging device. The imaging device may include an imaging sensor and lens assembly 120, designed to collect data. For example, the sensors 120 may be designed to collect images. The sensor may be a two-dimensional CMOS or CCS pixel array sensor. The imaging device may produce component red, green and blue values in the case of a three sensor configuration or a raw Bayer images consisting of interleaved red, blue and green-red and green-blue values. In an example, some sensors may have an integrated image processor and may produce ISO Y, U and V values in a format such as NV12. Other imaging sensors can be used as well. The image device may be a built-in or integrated component of the computing device 100, or may be a device that is externally connected to the computing device 100.

The sensor data may be transferred directly to an image signal processor 122 or the sensor data may be transferred directly to buffers 124 in memory 126. The memory device 126 may be a non-volatile storage medium, such as random access memory (RAM), or any other suitable non-volatile memory systems. For example, the memory device 126 may include dynamic random access memory (DRAM). The imaging sensor and lens assembly 120 may be connected through a pixel bus 128 to a pixel bus receiver 130. The sensor data may be received in the pixel bus receiver 130 before be transferred to the image signal processor 122 or the buffers 124. By storing images in buffer 124 during capture, the speed of capture may be limited only by the speed at which the sensors 120 may gather data. For example, the speed of capture may be limited only to the image capture rate of the image device.

The block diagram of FIG. 1 is not intended to indicate that the computing device 100 is to include all of the components shown in FIG. 1. Further, the computing device 100 may include any number of additional components not shown in FIG. 1, depending on the details of the specific implementation.

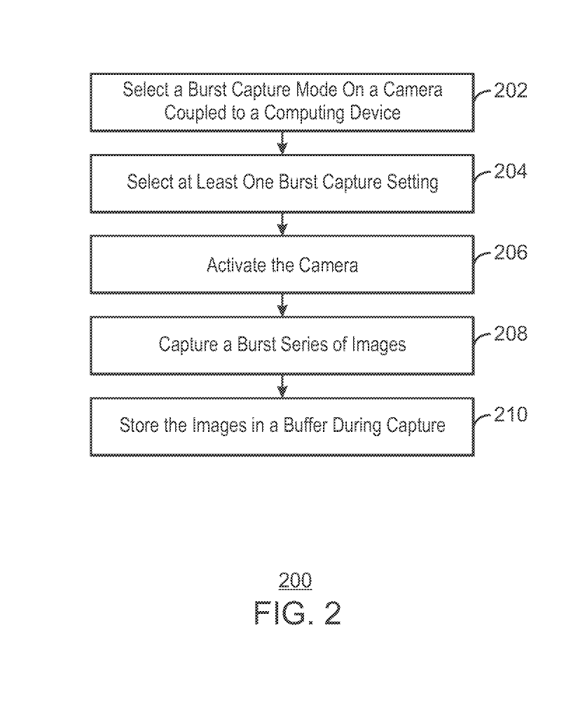

FIG. 2 is a flowchart illustrating a method 200 of capturing a burst series of images in accordance with an embodiment. At block 202, a burst capture mode is selected on a camera. The burst capture mode may be one of simple burst capture with fixed burst length, simple burst capture with image sequence stabilization, continuous burst capture, burst capture for ultra-lowlight image composition, burst capture with exposure bracketing for optional high dynamic range image composition, burst capture with focus bracketing, all-in-focus, adjustable DOF image composition, view-time adjustable DOF, and simulated short depth-of-field.

A simple burst capture with fixed burst length mode may be a simple burst capture of a sequence of images. A simple burst capture with image sequence stabilization mode may be a simple burst capture of a sequence of images in which image sequence stabilization is utilized, resulting in cropped, aligned images. A simple burst capture with best shot selection mode may be a simple burst capture of a sequence of images, possibly including image sequence stabilization, in which the captured images may be immediately presented to a user for selection of images to keep. A continuous burst capture mode may be a capture mode in which images are captured as long as a signal from a user is received. In an example, the signal may be the pressing of a shutter button and image capture may continue until the shutter button is released. An ultra-lowlight image composition mode may be similar to a fixed length burst capture mode except that the exposure may be calculated and set when a signal is received from a user. In this case, the exposure is usually biased to be shorter in time while the analog gain is increased accordingly. As above, the signal may be the pressing of a shutter button. An exposure bracketing mode may be a burst capture of a sequence of pictures with exposure biases applied to each image in the sequence such as for example −2 EV, 0 EV and +2 EV. The exposure biases may be specified as a range or an explicit list. A high dynamic range (HDR) image composition mode may be an exposure series burst capture in which the images are combined with adaptive tone mapping to preserve a higher dynamic range in the image dynamic range. Each captured image may be taken using a specific exposure bias and, in post-processing, the captures in the burst are combined into a single image where the exposure for each area is taken from the captured image with the best exposure for that area. In a focus bracketing mode, a burst capture of a sequence of pictures may be taken in which focus offsets are applied to each image in the sequence relative to a touch-to-focus area.

With use of devices such as ring buffers, either the full resolution raw sensor images are continually saved or the processed images are continually saved. This allows inclusion of images prior to when the shutter button was pressed by the user. In effect, the platform can capture burst sequences of images starting before the user presses the shutter button. This can often be helpful since the delays in the human response system for shutter button presses and latencies in the image preview display can be overcome.

In an all-in-focus, adjustable DOF image composition mode, several images may be captured, each with their own focus distance. In a post-processing step, the images may be combined such that the focused area from each picture is used. In a view-time adjustable DOF mode, the images may be captured and processed as in the all-in-focus, adjustable DOF image composition mode, except that the focus series may be preserved so that the user may dynamically adjust the focused region in the picture. In a simulated short depth-of-field mode, the images may be captured and processed as in the all-in-focus, adjustable DOF image composition mode, except that a user may select an area of the image, such as through touch, to be focused. The focused images are combined with intentionally defocused images from the foreground and background to simulate a very short depth of field, such as the depth of field provided by a very wide aperture lens.

The camera may be coupled to a computing device, such as a cell phone, a PDA, or a tablet. At block 204, at least one burst capture setting may be selected by a user. Burst capture settings may include burst capture length, burst capture frame rate, exposure, capture start time offset relative to shutter button press and any other relevant settings. Burst capture settings may also include picture format, white balance, image effect, scene mode, XNR, shutter priority, AE mode, AE metering mode, aperture priority, ISO, red eye correction, zoom factor, a WB mapping mode, and color temperature. A user may select the burst capture settings by accepting default settings. In an example, the user may accept the default settings for all of the burst capture settings. In another example, the user may accept the default settings for some of the burst capture settings and may manually set the remaining burst capture settings. In another example, the user may not accept any of the default settings and may manually set all of the burst capture settings.

In an example, the default burst capture length setting may be 5, and the minimum burst capture length may be 2, the maximum burst capture length may be 10. In another example, the default burst capture frame rate may be 5 frames per second (fps), the minimum burst capture frame rate may be 1 fps, and the maximum burst capture frame rate may be 15 fps.

At block 206, the user may activate the camera. Activating the camera may include sending a signal to the camera. For example, the user may press a button, such as a shutter button. The button may be a physical button or the button may be a graphical user interface (GUI), such as a designated position on a touchscreen.

At block 208, the camera may capture images. The camera may capture the images in a burst series, or a stream of images. The number of images may be captured at a set frame rate. For example, the images may be captured at a default frame rate. In another example, the images may be captured at a frame rate input by the user. The camera may produce an audible shutter sound at each capture. The type of audible shutter sound produced may depend on the frame rate. For example, the audible shutter sound may change to a motor winder sounds at frame rates greater than 5 fps.

The images may be stored in a buffer during capture. The images may be stored in a buffer during capture rather than storing the images in a storage device. For example, the images may be stored in the buffer until all of the images in the burst series have been taken. In an example, the number of images in the burst series may be set by the user. In another example, the number of images in the burst series may be determined by the size of the buffer. By saving the images to a buffer during capture, the speed of capture may be increased. For example, the speed of capture of the images may be limited only by the speed at which the sensors in the camera may provide data. The images may be processed after all of the images in the burst series have been captured.

A post-view display of each image may be presented to the user during capture. The post-view display may present the captured images to the user at the same frame rate at which the images are captured. After the last post-view image of the burst series is displayed, the image may scale down to a thumbnail in a portion of the display, such as the bottom right portion of the screen.

After the images have been captured, the images may be processed. For example, in a simple burst capture with fixed burst length mode, the captured images may be displayed to the user. In an example, the burst series of images may be grouped together in a photo gallery and the user may be able to expand the burst series to view the images. The captured images may be in any image format, such as JPEG, TIFF, PNG, RAW, YUV, GIF, BMP, or any other acceptable format. After the user has viewed the images, the images may be transferred to a storage medium, such as a Secure Digital (SD) card. In a simple burst capture with image sequence stabilization mode, stabilization may be turned on during capture, resulting in cropped, aligned images.

In a simple burst capture with best shot selection mode, the sequence of images may be immediately provided to the user. The user may select the images that will be kept. The selected images may be transferred to a storage medium. The unselected images may be deleted without being transferred to a storage medium. In an example, the user may select only one image, such as the best image in the burst series. In another example, the user may select more than one image. In a further example, the user may select all of the images in the burst series. In another example, the user may select the image or images to be saved during capture of the burst series. In a further example, the burst series may be saved as a logical group to a storage medium and the user may scan the sequence and select one or more images to save after the burst series has been saved to a storage medium. The unselected images may then be deleted from the storage medium.

In a continuous burst capture mode, the camera may continue to capture images in the burst series as long as the signal from the user continues. For example, the camera may continue to capture images as long as a shutter button is pressed. In another example, the camera may continue to capture images in the burst series until the shutter button is released or the buffer is full. The burst series may be saved to a storage medium after the entire burst series has been captured. The user may select the images to be saved to the storage medium, or all of the images in the burst series may be saved to the storage medium. The images in the burst series may be grouped in the storage medium.

In an ultra-lowlight image composition mode, the exposure may be calculated when a signal is received from the user. For example, the exposure may be calculated when a shutter button is pressed by the user. The calculated exposure may be set so that short exposure times are captured at a maximum frame rate, resulting in a cumulative exposure effect. Global displacement vectors may be calculated and the captured images may be registered according to their displacement vector, aligning the images. The aligned images may be composited or combined, and the pixels in the images average, resulting in a higher quality image under low light conditions.

In an exposure bracketing mode, exposure biases may be applied to each image in the burst series during image capture. The exposure biases may be specified as a range or an explicit list. The frame rate and length of capture may also be specified. The images from an exposure bracketing mode may each display different exposures.

In a high dynamic range (HDR) image composition mode, images may be captured as in an exposure bracketing mode. The exposure bias may depend on light conditions. For example, on a sunny day the bias may be large. The captured images may be combined to compress a higher dynamic range into the image dynamic range. In particular, the images in the exposure series may be combined into a single image. The exposure for each area of the single image may be taken from the captured image with the best exposure from that area. For example, each pixel of the single image may be an area. The resulting single image may have all areas, or pixels, properly exposed. In contrast, images without this feature may have some areas that are over-exposed and some areas that are under-exposed.

In a focus bracketing mode, the images in a burst series may be captured with focus offsets applied to each image in the sequence. In this way, each image in the burst series may have a unique focus. The focus offsets may be applied to each image in the sequence relative to a touch-to-focus area. The focus offsets may be specified in a range or an explicit list. In addition, the frame rate and length of capture may be specified. All of the captured images may be transferred from the buffer to a storage device. In another example, the user may select at least one image to be transferred from the buffer to a storage device.

In an all-in-focus, adjustable depth-of-field (DOF) image composition mode, a burst series of images may be captured as in the focus bracketing mode. As such, several images, each with their own focus distance, may be captured. In the post-processing step, the images of the burst series may be combined such that the focused area from each picture is used. The user may adjust both the all-in-focus and the depth-of-field. Captures may be taken only when the focus position has been reached. In another example, images may be taken continuously at a given frame rate until the focus position is reached. For example, the user may specify when images are taken. In an example, the user may limit the focus range around a particular focus distance instead of focusing the entire range. The composited single image may be transferred to a storage medium after processing is complete.

In a view-time adjustable DOF mode, the images in the burst series may be captured and processed as in the all-in-focus, adjustable DOF image composition mode. However, the focus series of the burst series may be preserved. The user may be presented with a slider, allowing the user to dynamically adjust the focused region in the composited image.

In a simulated short depth-of-field mode, the images in the burst series may be captured and processed as in the all-in-focus, adjustable DOF image composition mode. However, the user may select an area of the image to be focused. For example, the user may select the area of the image through touch, such as via a touchscreen. The focused images may be combined with intentionally defocused images from the foreground and background. By combining the focused images with defocused images, a very short depth of field may be simulated, such as the short depth of field that would be provided by a very wide aperture lens. In another example, the user may limit the focus range around a particular focus distance instead of focusing the entire range. For example, an in-focus face may be merged with a deliberately out of focus foreground and background.

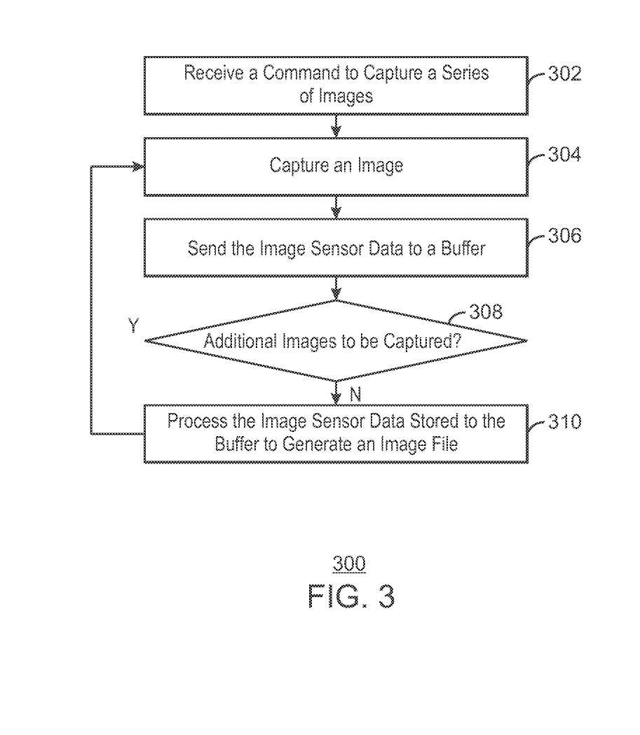

FIG. 3 is a flowchart illustrating a method 300 of capturing a burst series of images. At block 302, a command to capture a series of images is received. The command may comprise a signal from the user and may be received by an image capture device, such as a camera. For example, the user may press a button, such as a shutter button. The button may be a physical button or the button may be a graphical user interface (GUI), such as a designated position on a touchscreen. The time of the first capture can be specified as an offset to the signal from the user. The offset can be negative, meaning the first image of the capture sequence can be before the user input. In another example, the offset can be zero, meaning it corresponds to the image captured at the time of the user signal. In a further example, the offset can be positive, meaning the first image of the capture sequence can be the specified time after the user signal. The camera may be integrated with a computing device, such as a cell phone, a PDA, or a tablet.

At least one burst capture setting may be selected by a user. The user may select the burst capture settings before issuing a command to capture a series of images, after issuing a command, or simultaneously with issuing a command. Burst capture settings may include burst capture length, burst capture frame rate, exposure, and any other relevant settings. Burst capture settings may also include picture format, white balance, image effect, scene mode, XNR, shutter priority, AE mode, AE metering mode, aperture priority, ISO, red eye correction, zoom factor, a WB mapping mode, and color temperature. A user may select the burst capture settings by accepting default settings. In an example, the user may accept the default settings for all of the burst capture settings. In another example, the user may accept the default settings for some of the burst capture settings and may manually set the remaining burst capture settings. In another example, the user may not accept any of the default settings and may manually set all of the burst capture settings.

In an example, the default burst capture length setting may be 5, and the minimum burst capture length may be 2, the maximum burst capture length may be 10. In another example, the default burst capture frame rate may be 5 frames per second (fps), the minimum burst capture frame rate may be 1 fps, and the maximum burst capture frame rate may be 15 fps.

At block 304, an image may be captured. The image may be captured in a particular burst capture mode. The burst capture mode may be one of simple burst capture with fixed burst length, simple burst capture with image sequence stabilization, continuous burst capture, ultra-lowlight image composition, exposure bracketing, high dynamic range image composition, focus bracketing, all-in-focus, adjustable DOF image composition, view-time adjustable DOF, and simulated short depth-of-field. The user may select the burst capture mode. For example, the user may select the mode before issuing the command to capture the images. In another example, the user may select the mode after issuing the command to capture the images. In a further example, the user may select the mode as part of issuing the command to capture the images.

At block 306, the captured image sensor data may be stored in a buffer. By saving the image sensor data to a buffer during capture, the speed of capture may be increased. For example, the speed of capture of the series of images may be limited only by the speed at which the sensors in the camera may provide data.

At block 308, the device may determine if additional images are still to be captured. If yes, blocks 304 and 306 may be repeated. Capturing an image and storing the captured image sensor data may continue until all images in a series are captured. The images may be stored in a buffer in volatile memory during capture rather than storing the images in a non-volatile storage device. For example, the images may be stored in the buffer until all of the images in the burst series have been taken. In an example, the number of images in the burst series may be set by the user. For example, the number of images may be manually input by a user or may be a default number of images accepted by the user. In another example, the number of images in the burst series may be determined by the size of the buffer. In a further example, capture of images may continue as long a command persists. For example, the user may push a button to signal an image device to begin capturing images; image capture may continue until the button is released. In a further example, the image capture may begin when a button is pushed and may end when a button is pushed for a second time.

The camera may capture the images in a burst series, or a stream of images. The number of images may be captured at a set frame rate. For example, the images may be captured at a default frame rate. In another example, the images may be captured at a frame rate input by the user. The camera may produce an audible shutter sound at each capture. The type of audible shutter sound produced may depend on the frame rate. For example, the audible shutter sound may change to a motor winder sounds at frame rates greater than 5 fps.

A post-view display of each image may be presented to the user during capture. The post-view display may present the captured images to the user at the same frame rate at which the images are captured. After the last post-view image of the burst series is displayed, the image may scale down to a thumbnail in a portion of the display, such as the bottom right portion of the screen.

If no, at block 310, the images may be processed. For example, in a simple burst capture with fixed burst length mode, the captured images may be displayed to the user. In an example, the burst series of images may be grouped together in a photo gallery and the user may be able to expand the burst series to view the images. The captured images may be in any image format, such as JPEG, TIFF, PNG, RAW, YUV, GIF, BMP, or any other acceptable format. After the user has viewed the images, the images may be transferred to a storage medium, such as a Secure Digital (SD) card. In a simple burst capture with image sequence stabilization mode, stabilization may be turned on during capture, resulting in cropped, aligned images.

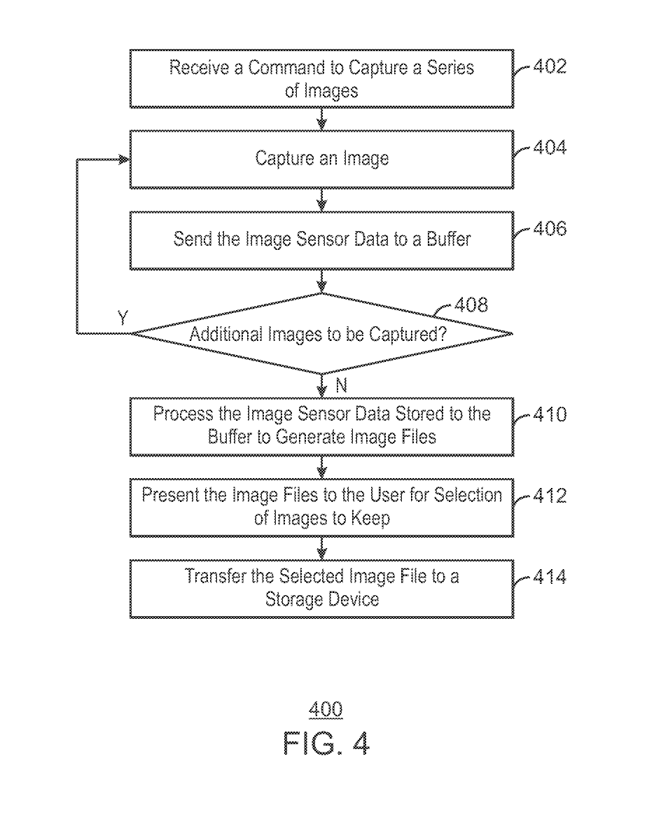

FIG. 4 is a flowchart illustrating a method 400 of capturing a burst series of images in accordance with an embodiment. At block 402, a command to capture a series of images may be received, such as in an image device. At block 404, an image may be captured. At block 406, the captured image data may be stored in a buffer. At block 408, the device may determine if additional images are to be captured. The number of images in the series may be determined by a user or may be determined by the size of the buffer. If yes, blocks 404 and 406 may be repeated. If no, at block 410, the image sensor data stored to the buffer may be processed to generate image files. At block 412, the image files may be presented to the user in order for the user to select the images to be kept. The user may select a single image to keep or the user may select multiple images to keep. At block 414, the selected images may be transferred to a storage device, such as an SD card. The unselected images may be deleted before being transferred to a storage device.

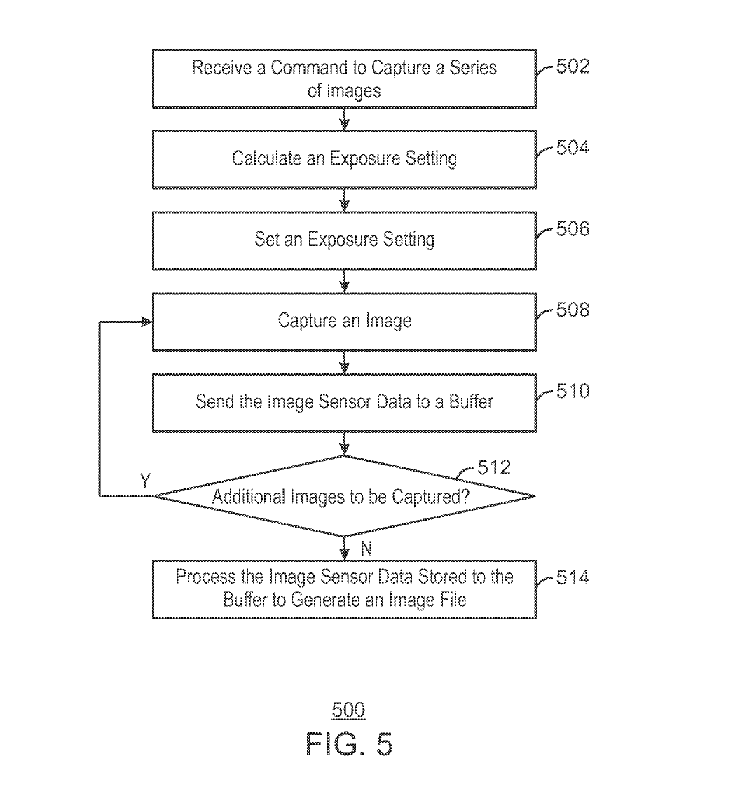

FIG. 5 is a flowchart illustrating a method 500 of capturing a burst series of images in accordance with an embodiment. At block 502, a command to capture a series of images may be received, such as by an image device. At block 504, the image capture device may calculate an exposure setting. At block 506, the image capture device may set the calculated exposure setting. At bock 508, the image device may capture an image. At block 510, the image device may store the capture image sensor data to a buffer. At block 512, the device may determine if additional images are to be captured. Capturing an image and sending the image sensor data to a buffer may continue until all images in a series have been captured. In another example, capture of the images may continue until the signal from the user ends. If no, at block 514, the image sensor data stored to the buffer may be processed to generate an image file. After processing, the image files may be transferred to a storage device, such as an SD card.

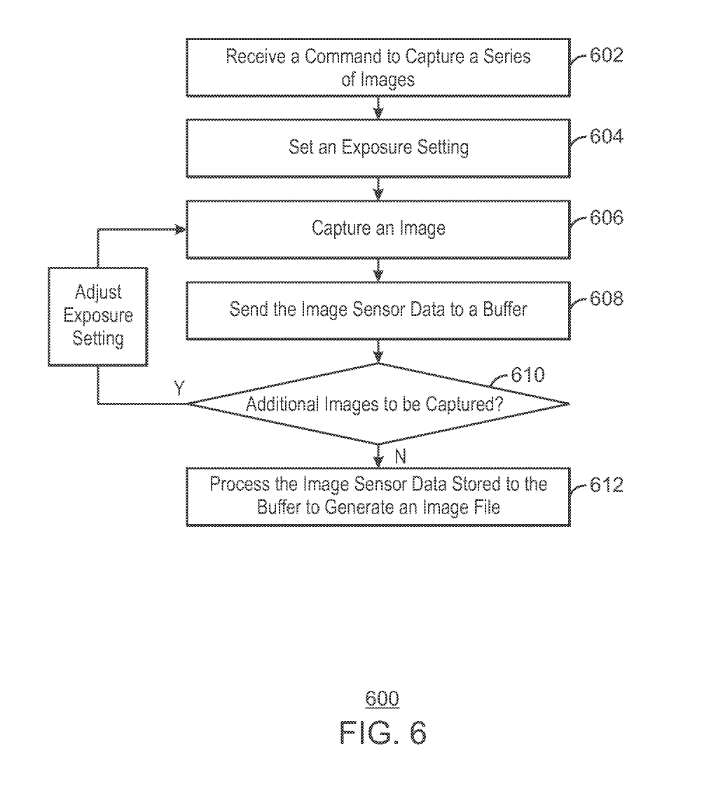

FIG. 6 is a flowchart illustrating a method 600 of capturing a burst sequence of images in accordance with an embodiment. At block 602, a command to capture a series of images may be received, such as by an image device. At block 604, an exposure setting may be set in the image device. The exposure setting may be manually input by the user. In another example, the exposure setting may be a default setting accepted by the user. In a further example, the exposure setting may be included in a list presented to the user and selected from the list by the user. The exposure setting may be set when the command is received from the user, after the command is received from the user, or as part of the command received from the receiver. At block 606, the image device may capture an image. At block 608, the capture image sensor data may be sent to a buffer. During capture, the images may be stored in a buffer, rather than a storage medium, such as an SD card. At block 610, the device may determine if additional images are to be captured. If yes, the exposure setting may be adjusted before blocks 606 and 608 are repeated. The exposure setting may be manually adjusted by a user or may be automatically adjusted by the image device. During automatic adjustment by the image device, the image device may calculate the adjusted exposure value, or may select the new exposure value from a preset list of exposure values. The preset list of values may be manually input by the user, calculated by the image device before capture, or selected by the user before capture. If no, at block 612, the image sensor data stored to the buffer may be processed to generate an image file. In an example, processing may include the method described above for HDR image composition mode, wherein the images are composited to form a single image. In another example, a series of image files may be generated and a user may specify an image or images to keep. The specified image may be transferred to a storage device, such as an SD card. In a further example, all of the image files may automatically be transferred to a storage device.

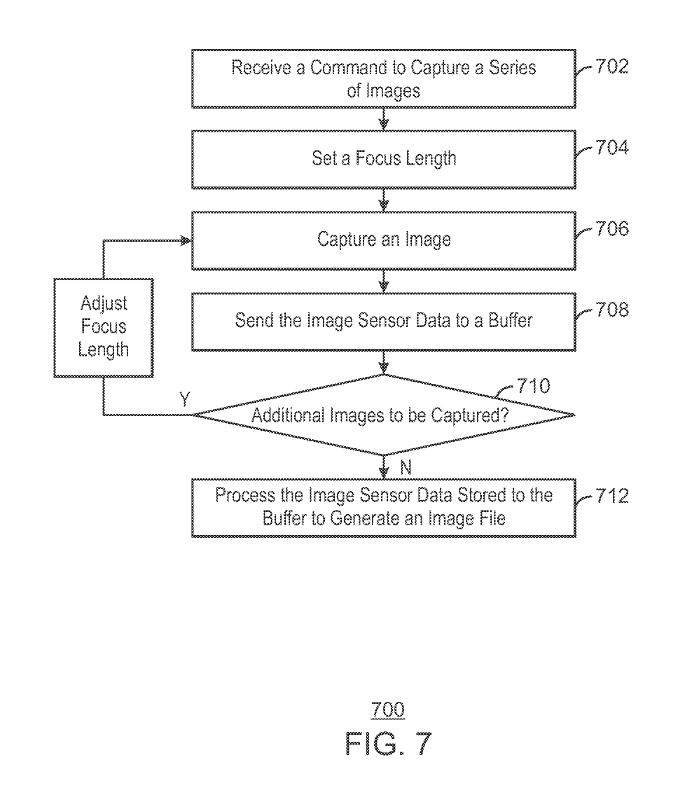

FIG. 7 is a flowchart illustrating a method 700 of capturing a burst sequence of images in accordance with an embodiment. At block 702, a command to capture a series of images may be received, such as by an image device. At block 704, a focus length may be set. The focus length may be input by a user or may be set by the image device. The focus length may be manually input by a user or may be selected from a list presented by the image device. At block 706, the image device may capture an image. The image device may capture a set number of images in a series or may capture numbers as long as a signal from a user persists, such as until a button is released. At block 708, the image device may send the captured image sensor data to a buffer. At block 710, the device may determine if additional images are to be captured. If yes, the focus length may be adjusted before blocks 706 and 708 are repeated. The focal length may be manually adjusted by a user or may be automatically adjusted by the image device. During automatic adjustment by the image device, the image device may calculate the adjusted focal length, or may select the new focal length from a preset list of focal lengths. The preset list of lengths may be manually input by the user, calculated by the image device before capture, or selected by the user before capture. Capturing an image and sending the image sensor data to a buffer may continue until all images in a series have been captured, adjusting the focal length before each image capture. If no, at block 712, the image sensor data stored to the buffer may be processed to generate an image file. For example, the images in a burst sequence may be combined during processing to form a single composite image. The composite image may be transferred to the storage device. In another example, all captured images in a series may be processed into image files. The user may select an image file or image files to be kept, or all image files may be kept. The images files may be transferred to a storage device.

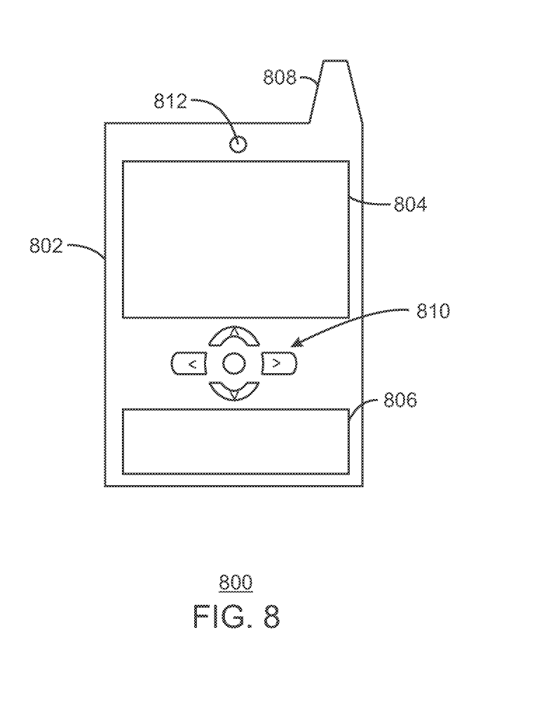

FIG. 8 is a schematic of a mobile device 800 in accordance with an embodiment. The system of FIG. 1 may be embodied in the mobile device 800. Mobile device 800 may be a laptop computer, ultra-laptop computer, tablet, touch pad, portable computer, handheld computer, palmtop computer, personal digital assistant (PDA), cellular phone, combination cellular phone/PDA, smart device (e.g., smart phone or smart tablet), mobile internet device (MID), messaging device, data communication device, or the like. For example, the mobile device 800 may be implemented as a smart phone capable of executing computer applications, as well as voice communications and/or data communications. Although some embodiments may be described with a mobile device implemented as a smart phone by way of example, it may be appreciated that other embodiments may be implemented using other wireless mobile computing devices as well.

As shown in FIG. 8, the device 800 may include a housing 802, a display 804, an input/output (I/O) device 806, an antenna 808, and a transceiver (not shown). The device 800 may also include navigation features 810. The display 804 may include any suitable display unit for displaying information appropriate for a mobile computing device. The I/O device 806 may include any suitable I/O device for entering information into a mobile computing device 800. For example, the I/O device 806 may include an alphanumeric keyboard, a numeric keypad, a touch pad, input keys, buttons, switches, rocker switches, microphones, speakers, a voice recognition device and software, or the like. Information may also be entered into the device 800 by way of a microphone (not pictured). Such information may be digitized by a voice recognition device.

The device 800 may also include an imaging device 812. Imaging device 812 may be embedded in the housing 802. The device 800 may include a single imaging device 812 or multiple imaging devices. The imaging device 812 may capture images, such as a series of images. The imaging device 812 may store the image data in a buffer, such as buffer 122, during capture. After capture, the imaging data stored in the buffer may be processed to create an image file. The image file may be stored in a storage device.

The schematic of FIG. 8 is not intended to indicate that the mobile device 800 is to include all of the components shown in FIG. 8. Further, the computing device 800 may include any number of additional components not shown in FIG. 8, depending on the details of the specific implementation.

### Example 1

A method is disclosed herein. The method includes performing a series of image captures, wherein each image capture comprises sending image sensor data from an image sensor to a buffer. After performing each of the series of image captures, the method includes processing the image sensor data stored to the buffer to generate an image file.

A speed of capture of the series of image captures may be limited only by an image capture rate of the image sensor. The method may include adjusting an image capture setting of the image sensor between each image capture of the series of image captures. The images may not be transferred to a storage medium until all images in the series are captured. After a series of image files are generated, the image files may be presented to a user for selection of an image file to keep. Performing a series of image captures may continue until a command from a user ends. Exposure may be calculated and set before performing a series of image captures. Exposure may be adjusted before capture of each image in the series of image captures. The images in the series of images may be composited to form a single image and the exposure of each area of the single image may be taken from the image in the series of images having a best exposure for the area. The time of the first capture may be specified as an offset to the user input event. Focal length may be adjusted before capture of each image in the series of image captures. The images in the series of images may be composited to form a single image and focus of each area of the single image may be taken from the image in the series of images having a best focus for the area, such that all areas of the single image are in focus. The images in the series of images are composited to form a single image and a user may dynamically adjust focus of the single image. The images in the series of images may be composited to form a single image and a user selects an area of the single image to be focused through touch.

### Example 2

An electronic device is disclosed herein. The electronic device includes an image sensor and a memory buffer coupled to the image sensor. The electronic device also includes a controller to capture a series of images from the image sensor and store the series of images to the buffer. Image files corresponding to each of the series of images may be generated after the entire series of images is captured and stored to the buffer.

A speed of capture of the series of image captures may be limited only by an image capture frame rate of the image sensor. The electronic device may comprise a mobile phone. The images may be transferred from the buffer to the non-volatile storage device after all images in the series of images are captured and processed. The series of images may be captured in a burst capture mode. The electronic device may include an antenna and a transceiver to communicate over a wireless network. The wireless network may by a cellular network. An image capture setting of the image sensor may be adjusted between each image capture of the series of image captures. The images may not be transferred to a storage medium until all images in the series are captured. After a series of image files are generated, the image files may be presented to a user for selection of an image file to keep. A series of image captures may continue until a command from a user ends. Exposure may be calculated and set before a series of images is captured. Exposure may be adjusted before capture of each image in the series of image captures. The images in the series of images may be composited to form a single image and the exposure of each area of the single image may be taken from the image in the series of images having a best exposure for the area. A time of a first capture may be specified as an offset to a user signal. Focal length may be adjusted before capture of each image in the series of image captures. The images in the series of images may be composited to form a single image and focus of each area of the single image may be taken from the image in the series of images having a best focus for the area, such that all areas of the single image are in focus. The images in the series of images may be composited to form a single image and a user may dynamically adjust focus of the single image. The images in the series of images may be composited to form a single image and a user may select an area of the single image to be focused through touch.

In the foregoing description and claims, the terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still co-operate or interact with each other.

Some embodiments may be implemented in one or a combination of hardware, firmware, and software. Some embodiments may also be implemented as instructions stored on a machine-readable medium, which may be read and executed by a computing platform to perform the operations described herein. A machine-readable medium may include any mechanism for storing or transmitting information in a form readable by a machine, e.g., a computer. For example, a machine-readable medium may include read only memory (ROM); random access memory (RAM); magnetic disk storage media; optical storage media; flash memory devices; or electrical, optical, acoustical or other form of propagated signals, e.g., carrier waves, infrared signals, digital signals, or the interfaces that transmit and/or receive signals, among others.

An embodiment is an implementation or example. Reference in the specification to “an embodiment,” “one embodiment,” “some embodiments,” “various embodiments,” or “other embodiments” means that a particular feature, structure, or characteristic described in connection with the embodiments is included in at least some embodiments, but not necessarily all embodiments, of the inventions. The various appearances of “an embodiment,” “one embodiment,” or “some embodiments” are not necessarily all referring to the same embodiments. Elements or aspects from an embodiment can be combined with elements or aspects of another embodiment.

Not all components, features, structures, characteristics, etc. described and illustrated herein need be included in a particular embodiment or embodiments. If the specification states a component, feature, structure, or characteristic “may”, “might”, “can” or “could” be included, for example, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

It is to be noted that, although some embodiments have been described in reference to particular implementations, other implementations are possible according to some embodiments. Additionally, the arrangement and/or order of circuit elements or other features illustrated in the drawings and/or described herein need not be arranged in the particular way illustrated and described. Many other arrangements are possible according to some embodiments.

In each system shown in a figure, the elements in some cases may each have a same reference number or a different reference number to suggest that the elements represented could be different and/or similar. However, an element may be flexible enough to have different implementations and work with some or all of the systems shown or described herein. The various elements shown in the figures may be the same or different. Which one is referred to as a first element and which is called a second element is arbitrary.

In the preceding description, various aspects of the disclosed subject matter have been described. For purposes of explanation, specific numbers, systems and configurations were set forth in order to provide a thorough understanding of the subject matter. However, it is apparent to one skilled in the art having the benefit of this disclosure that the subject matter may be practiced without the specific details. In other instances, well-known features, components, or modules were omitted, simplified, combined, or split in order not to obscure the disclosed subject matter.

While the disclosed subject matter has been described with reference to illustrative embodiments, this description is not intended to be construed in a limiting sense. Various modifications of the illustrative embodiments, as well as other embodiments of the subject matter, which are apparent to persons skilled in the art to which the disclosed subject matter pertains are deemed to lie within the scope of the disclosed subject matter.

While the present techniques may be susceptible to various modifications and alternative forms, the exemplary examples discussed above have been shown only by way of example. It is to be understood that the technique is not intended to be limited to the particular examples disclosed herein. Indeed, the present techniques include all alternatives, modifications, and equivalents falling within the true spirit and scope of the appended claims.

What is claimed is:

1. A method comprising:
performing a series of image captures, wherein each image capture comprises sending image sensor data from an image sensor to a buffer; and
after performing each of the series of image captures, processing the image sensor data stored to the buffer to generate an image file.

2. The method of claim 1, wherein a speed of capture of the series of image captures is limited only by an image capture rate of the image sensor.

3. The method of claim 1, comprising adjusting an image capture setting of the image sensor between each image capture of the series of image captures.

4. The method of claim 1, wherein the images are not transferred to a storage medium until all images in the series are captured.

5. The method of claim 1, wherein after a series of image files are generated, the image files are presented to a user for selection of an image file to keep.

6. The method of claim 1, wherein performing a series of image captures continues until a command from a user ends.

7. The method of claim 1, wherein exposure is calculated and set before performing a series of image captures.

8. The method of claim 1, wherein exposure is adjusted before capture of each image in the series of image captures.

9. The method of claim 8, wherein the images in the series of images are composited to form a single image and wherein the exposure of each area of the single image is taken from the image in the series of images having a best exposure for the area.

10. The method of claim 1, wherein a time of a first capture is specified as an offset to a user signal.

11. The method of claim 1, wherein focal length is adjusted before capture of each image in the series of image captures.

12. The method of claim 11, wherein the images in the series of images are composited to form a single image and wherein focus of each area of the single image is taken from the image in the series of images having a best focus for the area, such that all areas of the single image are in focus.

13. The method of claim 11, wherein the images in the series of images are composited to form a single image and wherein a user dynamically adjusts focus of the single image.

14. The method of claim 11, wherein the images in the series of images are composited to form a single image and wherein a user selects an area of the single image to be focused through touch.

15. An electronic device, comprising:
an image sensor;
a memory buffer coupled to the image sensor; and
a controller to capture a series of images from the image sensor and store the series of images to the buffer, wherein image files corresponding to each of the series of images are generated after the entire series of images is captured and stored to the buffer.

16. The electronic device of claim 15, wherein a speed of capture of the series of image captures is limited only by an image capture frame rate of the image sensor.

17. The electronic device of claim 15, wherein the electronic device comprises a mobile phone.

18. The electronic device of claim 15, wherein the images are transferred from the buffer to the non-volatile storage device after all images in the series of images are captured and processed.

19. The electronic device of claim 15, wherein the series of images is captured in a burst capture mode.

20. The electronic device of claim 15, wherein the electronic device comprises an antenna and a transceiver to communicate over a wireless network.

21. The electronic device of claim 15, wherein the wireless network comprises a cellular network.

22. The electronic device of claim 15, wherein an image capture setting of the image sensor is adjusted between each image capture of the series of image captures.

23. The electronic device of claim 15, wherein the images are not transferred to a storage medium until all images in the series are captured.

24. The electronic device of claim 15, wherein after a series of image files are generated, the image files are presented to a user for selection of an image file to keep.

25. The electronic device of claim 15, wherein a series of image captures continues until a command from a user ends.

26. The electronic device of claim 15, wherein exposure is calculated and set before a series of images is captured.

27. The electronic device of claim 15, wherein exposure is adjusted before capture of each image in the series of image captures.

28. The electronic device of claim 27, wherein the images in the series of images are composited to form a single image and wherein the exposure of each area of the single image is taken from the image in the series of images having a best exposure for the area.

29. The electronic device of claim 15, wherein a time of a first capture is specified as an offset to a user signal.

30. The electronic device of claim 15, wherein focal length is adjusted before capture of each image in the series of image captures.

31. The electronic device of claim 30, wherein the images in the series of images are composited to form a single image and wherein focus of each area of the single image is taken from the image in the series of images having a best focus for the area, such that all areas of the single image are in focus.

32. The electronic device of claim 30, wherein the images in the series of images are composited to form a single image and wherein a user dynamically adjusts focus of the single image.

33. The electronic device of claim 30, wherein the images in the series of images are composited to form a single image and wherein a user selects an area of the single image to be focused through touch.
